(19) United States
(12) Patent Application Publication
(10) Pub. No.: US 2018/0337935 A1
(43) Pub. Date: Nov. 22, 2018

(54) ANOMALOUS ENTITY DETERMINATIONS

(71) Applicant: EntIT Software LLC, Sunnyvale, CA (US)

(72) Inventors: Manish Marwah, Palo Alto, CA (US); Alexander Ulanov, Palo Alto, CA (US); Carlos Zubieta, Zapopan (MX); Luis Mateos, Zapopan (MX); Pratyusa K. Manadhata, Piscataway, NJ (US)

(21) Appl. No.: 15/596,042

(22) Filed: May 16, 2017

(51) Int. Cl. H04L 29/06

(52) U.S. Cl. CPC H04L 63/1425

(57) ABSTRACT

In some examples, a system generates a graphical representation of entities associated with a computing environment, and derives features for the entities represented by the graphical representation, the features comprising neighborhood features and link-based features, a neighborhood feature for a first entity of the entities derived based on entities that are neighbors of the first entity in the graphical representation, and a link-based feature for the first entity derived based on relationships of other entities in the graphical representation with the first entity. The system determines, using a plurality of anomaly detectors based on respective features of the derived features, whether the first entity is exhibiting anomalous behavior.

### BACKGROUND

A computing environment can include a network of computers and other types of devices. Issues can arise in the computing environment due to behaviors of various entities. Monitoring can be performed to detect such issues, and to take action to address the issues.

### BRIEF DESCRIPTION OF THE DRAWINGS

Some implementations of the present disclosure are described with respect to the following figures.

FIG. 1 is a block diagram of an arrangement including an analysis system to determine anomalous entities according to some examples.

FIG. 2 is a flow diagram of a process of detecting an anomalous entity according to some examples.

FIG. 3 illustrates a graphical representation of entities useable by a system to detect anomalous entities according to some examples.

FIGS. 4 and 5 illustrate parametric distributions of values of graph-based features useable by a system to detect anomalous entities according to some examples.

FIGS. 6 and 7 illustrate grids including data points and useable by a system to detect anomalous entities according to further examples.

FIG. 8 is a block diagram of a system according to some examples.

FIG. 9 is a block diagram of a storage medium storing machine-readable instructions according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

Certain behaviors of entities in a computing environment can be considered anomalous. Examples of entities can include users, machines (physical machines or virtual machines), programs, sites, network addresses, network ports, domain names, organizations, geographical jurisdictions (e.g., countries, states, cities, etc.), or any other identifiable element that can exhibit a behavior including actions in the computing environment. A behavior of an entity can be anomalous if the behavior deviates from an expected rule, criterion, threshold, policy, past behavior of the entity, behavior of other entities, or any other target, which can be predefined or dynamically set. An example of an anomalous behavior of a user involves the user making greater than a number of login attempts into a computer within a specified time interval, or a number of failed login attempts by the user within a specified time interval. An example of an anomalous behavior of a machine involves the machine receiving greater than a threshold number of data packets within a specified time interval, or a number of login attempts by users on the machine that exceed a threshold within a specified time interval.

Analysis can be performed to identify anomalous entities, which may be entities that are engaging in behavior that present a risk to a computing environment. In some examples, such analysis can be referred to as a User and Entity Behavior Analysis (UEBA). As examples, a UEBA system can use behavioral anomaly detection to detect a compromised user, a malicious insider, a malware infected device, a malicious domain name or network address (such as an Internet Protocol or IP address), and so forth.

Anomaly detection systems or techniques can be complex and may involve significant input of domain data pertaining to models used in performing detection of anomalous entities. Domain data can refer to data that relates to characteristics of a computing environment, entities of the computing environment, and other aspects that affect whether an entity is considered to be exhibiting anomalous behavior. Such domain data may have to be manually provided by human subject matter experts, which can be a labor-intensive and error-prone process.

In accordance with some implementations of the present disclosure, graph-based detection techniques or systems are provided to detect anomalous entities. A graphical representation of entities associated with a computing environment is generated, and features for the entities represented by the graphical representation are derived, where the features include neighborhood features and link-based features. In other examples, other types of features can be derived. Multiple anomaly detectors based on respective features of the derived features are used to determine whether the first entity is exhibiting anomalous behavior.

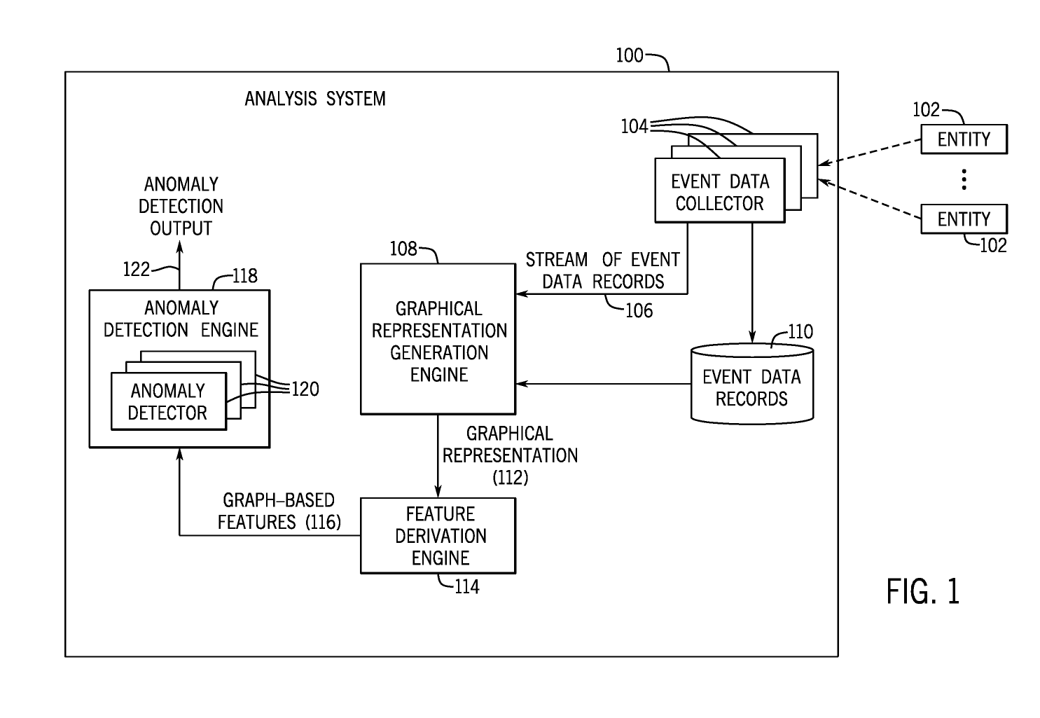

FIG. 1 is a block diagram of an example arrangement that includes an analysis system 100 and a number of entities 102, where the entities 102 can include any of the entities noted above. In some examples, the entities 102 can be part of an organization, such as a company, a government agency, an educational organization, or any other type of organization. In other examples, the entities 102 can be part of multiple organizations. The analysis system 100 can be operated by an organization that is different from the organization(s) associated with the entities 102. In other examples, the analysis system 100 can be operated by the same organization associated with the entities 102.

In some examples, the analysis system 100 can include a UEBA system. In other examples, the analysis system 100 can include an Enterprise Security Management (ESM) system, which provides a security management framework that can create and sustain security for a computing infrastructure of an organization. In other examples, other types of analysis systems 100 can be employed.

The analysis system 100 can be implemented as a computer system or as a distributed arrangement of computer systems. More generally, the various components of the analysis system 100 can be integrated into one computer system or can be distributed across various different computer systems.

In some examples, the entities 102 can be part of a computing environment, which can include computers, communication nodes (e.g., switches, routers, etc.), storage devices, servers, and/or other types of electronic devices. The computing environment can also include additional entities, such as programs, users, network addresses assigned to entities, domain names of entities, and so forth. The computing environment can be a data center, an information technology (IT) infrastructure, a cloud system, or any other type of arrangement that includes electronic devices and programs and users associated with such electronic devices and programs.

The analysis system 100 includes event data collectors 104 to collect data relating to events associated with the entities 102 of the computing environment. The event data collectors 104 can include collection agents (in the form of machine-readable instructions such as software or firmware modules, for example) distributed throughout the computing environment, such as on computers, communication nodes, storage devices, servers, and so forth. Alternatively, some of the event data collectors 104 can include hardware event collectors implemented with hardware circuitry.

Examples of events can include login events (e.g., events relating to a number of login attempts and/or devices logged into), events relating to access of resources such as websites, events relating to submission of queries such as Domain Name System (DNS) queries, events relating to sizes and/or locations of data (e.g., files) accessed, events relating to loading of programs, events relating to execution of programs, events relating to accesses made of components of the computing environment, errors reported by machines or programs, events relating to performance monitoring of various characteristics of the computing environment (including monitoring of network communication speeds, execution speeds of programs, etc.), and/or other events.

An event data record can include various attributes, such as a time attribute (to indicate when the event occurred), and further attributes that can depend on the type of event that the event data record represents. For example, if an event data record is to present a login event, then the event data record can include a time attribute to indicate when the login occurred, a user identification attribute to identify the user making the login attempt, a resource identification attribute to identify a resource in which the login attempt was made, and so forth.

Event data can include network event data and/or host event data. Network event data is collected on a network device such as a router, a switch, or other communication device that is used to transfer data between other devices. An event data collector 104 can reside in the network device, or alternatively, the event data collector can be in the form of a tapping device that is inserted into a network. Examples of network event data include Hypertext Transfer Protocol (HTTP) data, DNS data, Netflow data (which is data collected according to the Netflow protocol), and so forth.

Host event data can include data collected on computers (e.g., desktop computers, notebook computers, tablet computers, server computers, etc.), smartphones, or other types of devices. Host event data can include information of processes, files, applications, operating systems, and so forth.

The event data collectors 104 can produce a stream of event data records 106, which can be provided to a graphical representation generation engine 108 for processing by the graphical representation generation engine 108 in real time. As used here, an “engine” can refer to a hardware processing circuit or a combination of a hardware processing circuit and machine-readable instructions (e.g., software and/or firmware) executable on the hardware processing circuit. The hardware processing circuit can include any or some combination of the following: a microprocessor, a core of a multi-core microprocessor, a microcontroller, a programmable gate array, a programmable integrated circuit device, and so forth.

A “stream” of event data records can refer to any set of event data records that can have some ordering, such as ordering by time of the event data records, ordering by location of the event data records, or some other attribute(s) of the event data records. An event data record can refer to any collection of information that can include information pertaining to a respective event. Processing the stream of event data records 106 in “real time” can refer to processing the stream of event data records 106 as the event data records 106 are received by the graphical representation generation engine 108.

Alternatively or additionally, the event data records produced by the event data collectors 104 can be first stored into a repository 110 of event data records, and the graphical representation generation engine 108 can retrieve the event data records from the repository 110 to process such event data records. The repository 110 can be implemented with a storage medium, which can be provided by disk-based storage device(s), solid state storage device(s), and/or other type(s) of storage or memory device(s).

Based on the stream of event data records 106 and/or based on the event data records retrieved from the repository 110, the graphical representation generation engine 108 can generate a graphical representation 112 of the entities 102 associated with a computing environment. In some examples, a graphical representation of the entities 102 can be in the form of a graph that has nodes (or vertices) representing respective entities. An edge between a pair of the nodes represents a relationship between the nodes in the pair.

The data in the event data records can be used to construct the graphical representation 112 over a given time window of a specified length (e.g., a minute, an hour, a day, a week, etc.). In further examples, multiple time windows can be selected, where each time window of the multiple time windows is of a different time length. For example, a first time window can be a 10-minute time window, a second time window can be a one-hour time window, a third time window can be a six-hour time window, a fourth time window can be a 24-hour time window, and so forth.

Different graphical representations 112 can be generated by the graphical representation generation engine 108 for the different time windows. Choosing multiple time windows can allow for extraction of features that relate to different time periods. Anomaly detection as discussed herein can be applied for the different graphical representations generated for the different time windows of different time lengths.

A relationship represented by an edge between nodes of the graphical representation 112 (which represent respective entities) can include any of various different types of relationships, such as: a communication relationship where data (e.g., HTTP data, DNS data, etc.) is exchanged between the respective entities, a functional relationship where the respective entities interact with one another, a physical relationship where one entity is physically associated with another entity (e.g., a program is included in a computer, a first switch is directly connected by a link to a second switch, etc.), or any other type of relationship.

In some examples, each edge between nodes in the graphical representation 112 can be assigned a weight. The weight can vary in value depending upon characteristics of the relationship between entities corresponding to the edge. For example, the value of a weight can be assigned based on any of the foregoing: the number of connections (or sessions) between entities (such as machines or programs), the number of packets or amount of bytes transferred between the entities, the number of login attempts by a user on a machine, the number of times an entity accessed a file, a size of a file accessed by an entity, and so forth.

Graphical representations can also be constructed from both network event data and host event data, where such graphical representations can be referred to as heterogeneous graphical representations. In other examples, a first graphical representation can be constructed from network event data, while a second graphical representation can be constructed from host event data.

In some examples, edges in the graphical representation 112 are directed edges. A directed edge is associated with a direction from a first node to a second node in the graphical representation 112, to indicate the direction of interaction (e.g., a first entity represented by the first node sent a packet to a second entity represented by the second node). In such examples, weights are assigned to the directed edges (e.g., a first weight is assigned to a first edge between two nodes to represent a relationship in a first direction between the two nodes, and a second weight is assigned to a second edge between the two nodes to represent a relationship in a second direction between the two nodes).

In further examples, an edge between nodes can be direction-less. Such an edge can be referred to as a non-directional edge. For example, multiple edges between nodes can be consolidated into one edge, where weights assigned to the multiple edges are combined (e.g., summed, averaged, etc.) to produce a weight for the consolidated edge. A direction-less edge can be used in various scenarios, such as any of the following, for example: there is no natural direction, e.g., the edge corresponds to the nodes/entities being physically connected, or the edge was created due to similarity between the nodes; a direction is not important or obvious, e.g., when the nodes represent a user and a file, and the edge relates to the user accessing the file; and so forth.

The graphical representation 112 (or multiple graphical representations 112) produced by the graphical representation engine 108 can be provided to a feature derivation engine 114. The feature derivation engine 114 derives features for the entities represented by the graphical representation 112.

A “feature” can refer to any attribute associated with an entity. A “derived feature” can refer to an attribute that is computed by the feature derivation engine 114 based on other information, including information in the graphical representation 112 and/or information computed using the information in the graphical representation 112.

The derived features generated by the feature derivation engine 114 can include neighborhood features and link-based features, where a neighborhood feature for a given entity is derived based on entities that are neighbors of the given entity in the graphical representation 112, and a link-based feature for the given entity is derived based on relationships of other entities in the graphical representation 112 with the given entity.

Neighborhood features and link-based features are discussed further below. In other examples, other types of features can be derived.

The derived features produced by the feature derivation engine 114 based on the graphical representation 112 (or based on multiple graphical representations 112) are output as graph-based features 116 from the feature derivation engine 114 to an anomaly detection engine 118.

The anomaly detection engine 118 is able to determine whether an entity is exhibiting anomalous behavior using the graph-based features 116 from the feature derivation engine 114. The anomaly detection engine 118 can produce measures based on the graph-based features 116, where the measures can include parametric measures or non-parametric measures as discussed further below.

The anomaly detection engine 118 includes multiple anomaly detectors 120 that are applied to respective different features of the graph-based features 116. For example, a first anomaly detector 120 can base its anomaly detection on a first graph-based feature 116 (or a first subset of graph-based features), a second anomaly detector 120 can base its anomaly detection on a second graph-based feature 116 (or a second subset of graph-based features), and so forth.

Based on the detection performed by the anomaly detectors 120, the anomaly detectors 120 provide respective anomaly scores. An anomaly score can include information that indicates whether or not an entity is exhibiting anomalous behavior. An anomaly score can include a binary value, such as in the form of a flag or other type of indicator, that when set to a first state (e.g., “1”) indicates an anomalous behavior, and when set to a second state (e.g., “0”) indicates normal behavior (i.e., non-anomalous behavior). In further examples, an anomaly score can include a numerical value that indicates a likelihood of anomalous behavior. For example, the anomaly score can range in value between 0 and 1, where 0 indicates with certainty that the entity is not exhibiting anomalous behavior, and a 1 indicates that the entity is definitely exhibiting anomalous behavior. Any value that is greater than 0 or less than 1 provides an indication of the likelihood, based on the confidence of the respective anomaly detector 120 that produced the anomaly score. In other examples, an anomaly score that ranges in value between 0 and 1 can also be referred to as a likelihood score. In other examples, instead of ranging between 0 and 1, an anomaly score can have a range of different values to provide indications of different confidence amounts of the respective anomaly detector 120 in producing the anomaly score. In further examples, an anomaly score can be a categorical value that is assigned to different categories (e.g., low, medium, high).

The anomaly scores from the multiple anomaly detectors 120 can be combined to produce an anomaly detection output 122, where the anomaly detection output 122 can indicate whether or not a respective entity is an anomalous entity that is exhibiting anomalous behavior. The combining of the anomaly scores from the multiple anomaly detectors 120 can be a sum or other mathematical aggregate of the anomaly scores, such as an average, a weighted sum, a weighted average, a maximum, a harmonic mean, and so forth. A weighted aggregate (e.g., a weighted sum, a weighted average, etc.) is computed by multiplying a weight by each anomaly score, and then aggregating the products.

The anomaly detection output 122 can include the aggregate anomaly score produced from combining the anomaly scores from the multiple anomaly detectors 120, or some other indication of whether or not an entity is exhibiting an anomalous behavior.

In further examples, the anomaly detectors 120 can be ranked to identify a specified number of top-ranked anomaly detectors. Each anomaly detector 120 can produce a confidence score indicating its confidence in producing a respective anomaly score. The ranking of the anomaly detectors 120 can be based on the confidence scores. Instead of using all of the anomaly detectors 120 to identify an anomalous entity, just a subset (less than all) of the anomaly detectors 120 can be selected, where the selected anomaly detectors 120 can be the M top-ranked anomaly detectors 120 (where M 1).

Although FIG. 1 shows multiple engines 108, 114, and 118, it is noted that in further examples, some or all of the engines 108, 114, and 118 can be integrated into a common machine or program. Alternatively, in further examples, functionalities of each engine 108, 114, or 118 can be separated into multiple engines.

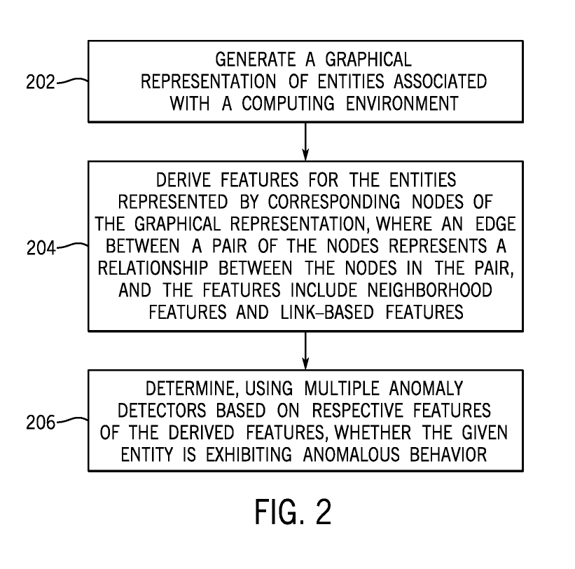

FIG. 2 is a flow diagram of an example process that can be performed by the analysis system 100 according to some implementations of the present disclosure. The process includes generating (at 202), such as by the graphical representation generation engine 108, a graphical representation of entities associated with a computing environment.

The process further includes deriving (at 204), such as by the feature derivation engine 114, features for the entities represented by corresponding nodes of the graphical representation, where an edge between a pair of the nodes represents a relationship between the nodes in the pair, and the features include neighborhood features and link-based features. A neighborhood feature for a given entity is derived based on entities that are neighbors of the given entity in the graphical representation, and a link-based feature for the given entity is derived based on relationships of other entities throughout the graphical representation with the given entity.

The process further includes determining (at 206), using multiple anomaly detectors (e.g., 120) based on respective features of the derived features, whether the given entity is exhibiting anomalous behavior.

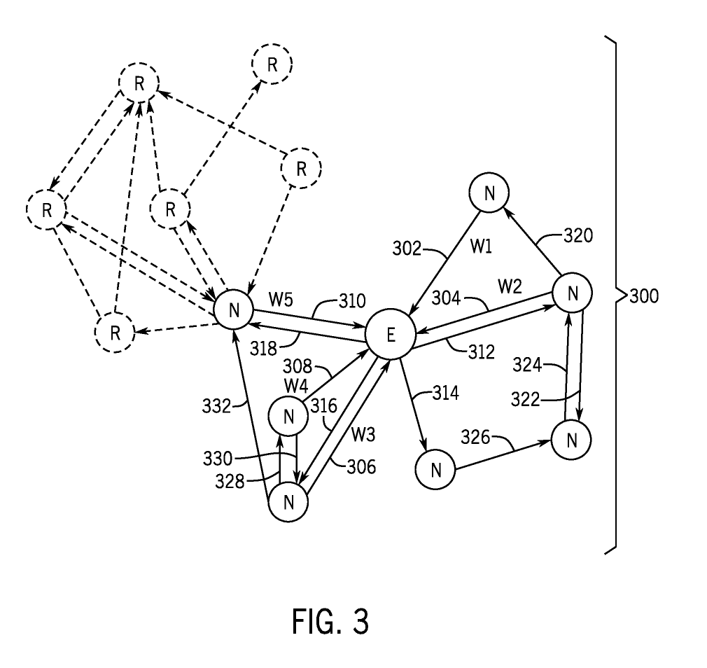

FIG. 3 illustrates an example graph 300 (which is an example of the graphical representation 112 of FIG. 1). The graph 300 includes various nodes (represented by circles) and edges between nodes. Each node represents a respective entity, and each edge between a pair of nodes represents a relationship between the nodes of the pair.

Although just one edge is shown between each pair of nodes in the graph 300, it is noted that in further examples, multiple edges can be present between a pair of nodes. Moreover, edges are shown as directed edges in FIG. 3—in other examples, some edges may be non-directional.

The graph 300 can be generated by the graphical representation generation engine 108 of FIG. 1. Using the graph 300, the feature derivation engine 114 of FIG. 1 can derive various graph-based features (e.g., 116 in FIG. 1).

The graph-based features can include neighborhood features and link-based features. In other examples, other types of features can be derived. More generally, the graph-based features are according to the structure and attributes of the graph 300.

Neighborhood Features

A neighborhood feature (also referred to as a local feature) for a given entity is derived based on entities that are neighbors of the given entity in the graph 300. In FIG. 3, a neighborhood feature for a node E is derived from the local neighborhood of the node E. In the example of FIG. 3, the local neighborhood of the node E includes nodes N, which in the example are directly linked to the node E. The local neighborhood of the node E does not include nodes R (shown in dashed profile), which in the example of FIG. 3 are not directly linked to the node E.

Although a specific example of a local neighborhood of the node E is shown in FIG. 3, it is noted that in other examples, other local neighborhoods can be defined, where a local neighborhood can include those nodes (“neighbor nodes”) that are within a specified proximity of a given node. In some examples, the specified proximity can be a number of steps (or hops) that the nodes are from the given node. A step (or hop) represents a number (zero or more) of intervening nodes between the given node and another node. If a node is within the number of steps of the given node, then the node is a neighbor node and is part of the local neighborhood.

In other examples, the specified proximity can be based on whether the other nodes are in a specified physical proximity of the given node (e.g., the other nodes are on the same rack as the given node, the other nodes are in the same building as the given node, the other nodes are in the same city as the given node, etc.). In further examples, the specified proximity can be based on whether the other nodes have a specified logical relationship to the given node (e.g., the other nodes are able to interact or communicate with the given node). In alternative examples, the local neighborhood of the given node can be defined in a different manner.

Examples of neighborhood features that can be derived from the structure and attributes of the local neighborhood of the node E in the graph 300 can include the following:
1. In-degree of the node E, which represents the number of incoming edges to the node E, which in the example of FIG. 3 include incoming edges 302, 304, 306, 308, and 310 (i.e., the in-degree of the node E is five in the example of FIG. 3).
2. Out-degree of the node E, which represents the number of outgoing edges from the node E, which in the example of FIG. 3 includes outgoing edges 312, 314, 316, and 318 (i.e., the out-degree of the node E is four in the example of FIG. 3).
3. Aggregate incoming weight at the node E, which represents an aggregate (e.g., sum, average, maximum, minimum, mean, etc.) of the weights W1, W2, W3, W4, and W5 assigned to the incoming edges 302, 304, 306, 308, and 310, respectively.
4. Aggregate outgoing weight at the node E, which represents an aggregate (e.g., sum, average, maximum, minimum, mean, etc.) of the weights W1, W2, W3, W4, and W5 assigned to the outgoing edges 312, 314, 316, and 318, respectively.

In other examples, other neighborhood features can be derived.

In a more specific example, a k-step egonet can be computed for each of the nodes of the graph 300. A k-step (k≥1) egonet of a given node includes the given node, all of the given node's k-step neighbors, and all edges between any of the given node's k-step neighbors or the given node.

In FIG. 3, a 1-step egonet of the node E includes the node E, the nodes N that are one step from the node E (i.e., the immediate neighbors of the node E), edges between the node E and the nodes N (including edges 302, 304, 312, 314, 306, 316, 308, 318, and 310), and edges between the nodes N (including edges 320, 322, 324, 326, 328, 330, and 332). The 1-step egonet of the node E excludes nodes R and edges of the nodes R to other nodes.

Once a k-step egonet of a given node is computed, the following neighborhood features can be derived based on the k-step egonet:
1. Total number of edges in the k-step egonet.
2. Total number of nodes in the k-step egonet.
3. Total weight in the k-step egonet.
4. Principal eigenvalue or eigenvector of the k-step egonet. The k-step egonet can be represented as a matrix. Assuming there are N nodes (N>1) in the k-step egonet, then the matrix representing the k-step egonet can be an N×N matrix, where N rows of the N×N matrix correspond to the respective N nodes, and N columns of the N×N matrix correspond to the respective N nodes. The entry (i, j) of the N×N matrix corresponds to the weight on the edge from node i to node j. If such an edge does not exist, the corresponding matrix entry is zero. If the edges are undirected, the matrix is symmetric, otherwise it may not be symmetric. From the N×N matrix, eigenvalues can be computed. The eigenvalue of the largest value can be referred to as the principal eigenvalue. Each eigenvalue is associated with an eigenvector. The eigenvector corresponding to the eigenvalue with the largest value is referred to as a principal eigenvector.
5. Maximum degree in the k-step egonet. In graph theory, the degree of a node (or vertex) of the graph is the number of edges incident to the node. The maximum degree of the k-step egonet is the degree of the node in the k-step egonet having the largest degree (from among multiple degrees of respective nodes in the k-step egonet).
6. Minimum degree in the k-step egonet. The minimum degree of the k-step egonet is the degree of the node in the k-step egonet having the smallest degree (from among multiple degrees of respective nodes in the k-step egonet).

In other examples, other neighborhood features can be derived from the k-step egonet.

Link-Based Features

A link-based feature (also referred to as a global feature) for a given entity is derived based on relationships of other entities in the graph 300 with the given entity.

Generally, link-based features for a node of the graph 300 are derived based on the global structural properties of the graph 300.

Examples of link-based features include a PageRank, a Reverse PageRank, a hub score using the Hyperlink-Induced Topic Search (HITS) technique, and an authority score using the HITS technique. In other examples, other link-based features can be derived.

The computation of a PageRank is based on a link analysis that assigns numerical weighting to each node of the graph 300 to measure the relative importance of the node within the set of nodes of the graph 300. The measure of the relative importance of a node (such as the node E in FIG. 3) is based on the number of links (edges) from other nodes to the node E. A link from another node to the node E is considered a vote of support for the node E. The larger the number of links to the node E, the larger the number of votes of support.

A reverse PageRank is computed by first reversing the direction of the edges in the graph 300, and then computing PageRank for each node using the PageRank computation discussed above.

The HITS technique (also referred to as a hubs and authorities technique) is a link analysis technique that can be used to rate nodes of a graph, based on the notion that certain nodes, referred to as hubs, served as large directories that were not actually authoritative in the information that they held, but were used as compilations of a broad catalog of information that led to other authoritative pages. In other words, a hub represents a node that points to a relatively large number of other pages, and an authority represents a node that is linked by a relatively large number of different hubs. The HITS technique assigns two scores for each node: its authority score, which estimates the value of the content of the node, and its hub score, which estimates the value of its links to other nodes. The HITS technique used in examples of the present disclosure is similar to that used for a web graph. The input to the HITS technique is the graph, and the authority score and hub score of a node depends on its in-degree and out-degree.

Parametric Anomaly Detection

Detection of anomalous entities can be based on probability distributions (also referred to as densities) computed for respective derived graph-based features as derived by the feature derivation engine 114 of FIG. 1. Examples of graph-based features can include neighborhood features and/or link-based features and/or other types of features.

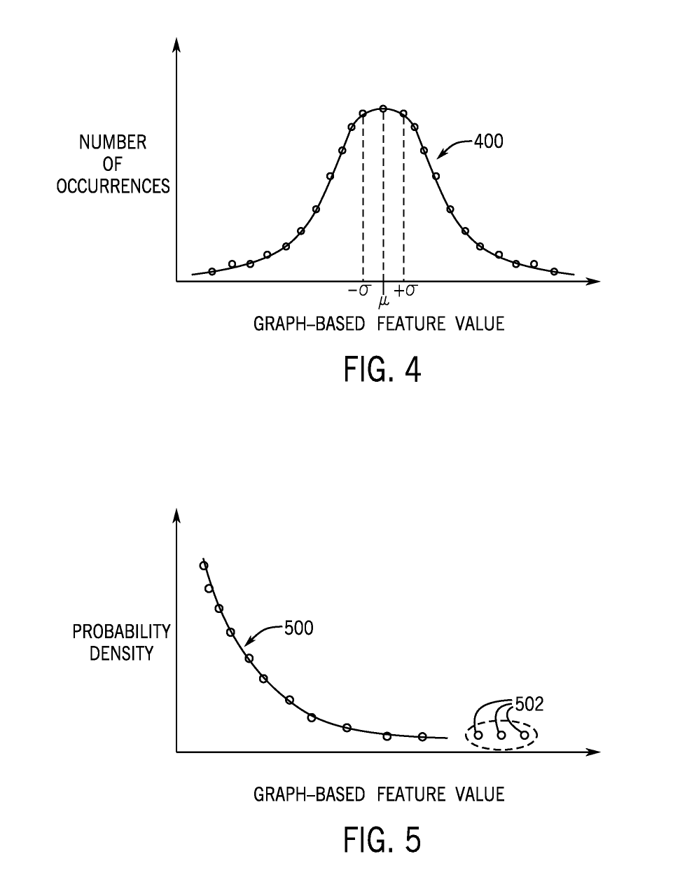

A probability distribution of a given graph-based feature can refer to a distribution of observed values of the given graph-based feature (e.g., the in-degree of the node E in the graph 300), where for each value of the given graph-based feature, the number of occurrences of the value is indicated in the distribution. A distribution of the given graph-based feature is a parametric distribution if the distribution is parameterized by certain parameters, such as the mean and standard deviation of the distribution. A parametric distribution with a mean and a standard deviation is also referred to as a normal distribution, such as the normal distribution 400 shown in FIG. 4. In FIG. 4, the vertical axis represents a number of occurrences of each value of a graph-based feature represented by the horizontal axis. In FIG. 4, the mean of the distribution 400 is represented as p, and the standard deviation is represented as G.

In another example, a parametric distribution can be a power law distribution. A power law is a functional relationship between two quantities, where a relative change in one quantity results in a proportional relative change in the other quantity. A first quantity varies as a power of another.

An example of a power law distribution 500 is shown in FIG. 5, which can be expressed as:

$$p ( x ; {x}_{min} , α ) = \frac{α - 1}{{x}_{min}} {( \frac{x}{{x}_{min}} )}^{- α} ,$$

where x is an input quantity (represented by the horizontal axis), and p(x; xₘᵢₙ, α) is the probability density (represented by the vertical axis) that is a power of the input quantity, x. The input quantity, x, can be a graph-based feature as discussed above.

For the power law distribution, the parameters xₘᵢₙ and a parameterize the power law distribution.

In other examples, other types of parametric distributions can be characterized by other parameters. Other examples can include a gamma distribution that is parametrized by a shape parameter, k and a scale parameter, θ; a t-distribution parametrized by degrees of freedom parameter, and so forth.

For each parametric distribution (e.g., normal distribution, power law distribution, etc.), the parameters that parameterize the parametric distribution can be estimated based on “normal” event data, i.e., event data known to not include those of anomalous entities. Such event data can be referred to as training data.

In some examples, multiple parametric distributions can be computed for each graph-based feature individually. Given values of a respective graph-based feature (such as values of the respective graph-based feature computed based on historical event data records), multiple parametric distributions (including those noted above) can be generated for the respective graph-based feature.

An anomaly detector 120 in the anomaly detection engine 118 (FIG. 1) can consider the multiple different parametric distributions for each individual graph-based feature.

Two phases can be performed by the anomaly detector 120. A first phase (training phase) uses historical data to determine which of the multiple parametric distributions to use by comparing the likelihoods of the historical data given a parametric distribution. The computed likelihood represents the probability of observing a data point (or set of data points) given a respective parametric distribution. The parameters of each parametric distribution are estimated. The distribution with the maximum likelihood is selected. Once a distribution is selected, then a validation data set can be used to determine a threshold for each of the parametric distributions. A validation data set includes data points, some of which are known to not represent anomalous entities, and others of which are known to represent anomalous entities. Using the validation data set, a threshold in a parametric distribution can be selected, which is the threshold that divides the data points that are known to not represent anomalous entities from the data points that are known to represent anomalous entities. The threshold can be set by a human analyst, or by a machine or program based on a machine learning process, for example.

Once the parametric distribution is selected and the corresponding threshold is known, a second phase (an anomalous entity detection phase) can be performed, where the anomaly detector 120 is ready to detect anomalous data points. Given a new data point or set of data points (i.e., feature values), the anomaly detector 120 computes its likelihood based on the selected distribution and selected parameters, and the anomaly detector 120 uses the threshold to determine if the data point or set of data points corresponds to an anomalous entity.

The above procedure can be used for individual features, or joint features

Each respective parametric distribution is associated with a likelihood function. For example, for the normal distribution, a log likelihood function can be used to compute the likelihood of a data point occurring given the normal distribution. Similarly, a power law distribution has a log likelihood function that can be used to compute the likelihood of a data point occurring given the power law distribution.

This selected likelihood is then compared to a threshold of the given parametric distribution—if the selected likelihood is less than (or has some other specified relationship, such as greater than, within a range of, etc.) the threshold of the given parametric distribution, then the currently considered data point (or set of data points) is marked as indicating an anomalous entity.

For example, in FIG. 5, the power law distribution 500 can be computed based on historical data. Data points 502 in FIG. 5 can containing values of derived graph-based features, and the data points 502 are to be processed by the anomaly detector 120 to determine whether the data points 502 indicate that an entity is exhibiting anomalous behavior. The data points 502 have low likelihoods, and if such likelihoods are less than a specified threshold for the power law distribution 500, then the data points 502 indicate an anomalous entity.

In the foregoing, reference is made to computing parametric distributions for each graph-based feature individually. In further examples, each parametric distribution can be computed for a subset of multiple graph-based features, such as a pair of graph-based features or a subset of more than two graph-based features. A parametric distribution computed based on a subset of multiple graph-based features can be referred to as a multivariate or joint parametric distribution.

For example, a multivariate normal distribution can have multiple different horizontal axes representing respective different graph-based features of the subset of graph-based features. Similarly, a multivariate power law distribution can have multiple different horizontal axes representing respective different graph-based features of the subset of graph-based features.

Thresholds can be determined for each multivariate parametric distribution, and such thresholds can be used to determine whether a currently considered data point (or set of data points) indicates an anomalous entity.

More generally, a first anomaly detector 120 can compute a first parametric distribution of a first subset of the graph-based features (where the first subset can include just one graph-based feature, a pair of graph-based features, or more than two graph-based features), and determines whether a given entity is exhibiting anomalous behavior based on the parametric distribution. The given anomaly detector 120 determines whether the given entity is exhibiting anomalous behavior based on a threshold for the first parametric distribution.

A second anomaly detector 120 can compute a second parametric distribution of a different second subset of the graph-based features, and determines whether the given entity is exhibiting anomalous behavior based on the second parametric distribution.

Non-Parametric Anomaly Detection

In alternative examples, instead of performing anomaly detection using parametric distributions, non-parametric anomaly detection for detecting anomalous entities can be performed.

For example, an anomaly detector 120 can explore pair-wise relationships between graph-based features (two graph-based features, or more than two graph-based features). Instead of fitting a parametric function (that represents a parametric distribution), the anomaly detector 120 can estimate a density of data points in a neighborhood of a currently considered data point (that represents the graph-based features for a currently considered entity). Essentially, given the currently considered data point, the anomaly detector 120 can retrieve the K (K 1) nearest neighbors to the currently considered data point, and estimate the density of the currently considered data point based on the distances of the currently considered data point to the K nearest neighbors.

This computed density is then used to estimate an anomaly score for the currently considered entity.

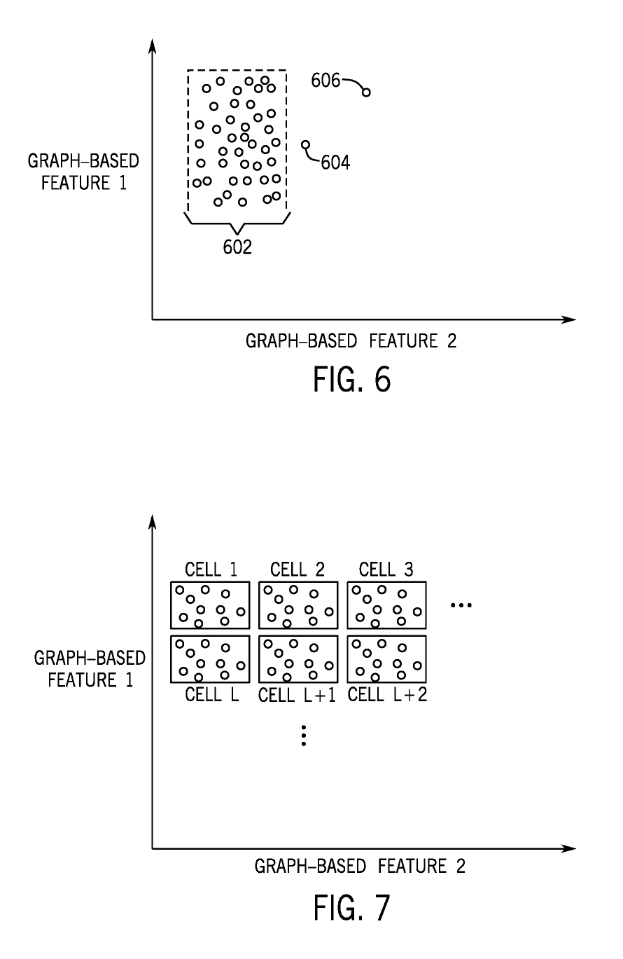

FIG. 6 is an example plot of various data points 602 (each data point represented by a small circle), where each data point 602 represents a pair of graph-based features derived for entities. The plot of FIG. 6 is a two-dimensional plot that associates the first and second features with one another.

The vertical axis of the plot of FIG. 6 represents a first graph-based feature, and the horizontal axis of the plot of FIG. 6 represents a second graph-based feature.

The position of a given data point 602 on the plot is based on the value of the first graph-based feature and the value of the second graph-based feature in the given data point 602.

In the example of FIG. 6, two newly received data points 604 and 606 are considered by a given anomaly detector 120. The given anomaly detector 120 determines the distances of the data point 604 to its K nearest neighbors (the K data points nearest the data point 604 in the plot shown in FIG. 6). The given anomaly detector 120 computes an aggregate (e.g., an average, a sum, or other mathematical aggregate) of the distances of the data point 604 to its K nearest neighbor, and produces a density (the aggregate distance) for the data point 604.

Similarly, the given anomaly detector 120 determines the distances of the data point 606 to its K nearest neighbors (the K data points nearest the data point 606 in the plot shown in FIG. 6). The given anomaly detector 120 computes an aggregate of the distances of the data point 606 to its K nearest neighbor, and produces a density (the aggregate distance) for the data point 606.

The aggregate distance of the data point 604 and the aggregate distance of the data point 606 are compared to a specified threshold distance. If the aggregate distance is greater than the specified threshold distance (or has some other specified relationship to the specified threshold distance), then the corresponding data point is indicated as representing an anomalous entity. In the example of FIG. 6, the aggregate distance of the data point 604 is less than the specified threshold, and thus the data point 604 does not indicate an anomalous entity. However, the aggregate distance of the data point 606 exceeds the specified threshold, and thus the data point 606 indicates an anomalous entity.

Effectively, with the non-parametric detection technique discussed above, the given anomaly detector 120 looks for an isolated data point in the plot of FIG. 6, which is a data point with a low density of neighboring data points.

In the example of FIG. 6, the given anomaly detector 120 is used to identify anomalous entities based on graph-based features of a first subset of graph-based features, which includes the first graph-based feature and the second graph-based feature shown in FIG. 6.

Another anomaly detector can be used to identify anomalous entities based on graph-based features (two or more) of another subset of graph-based features. Further anomaly detectors can be used to identify anomalous entities based on graph-based features (two or more) of respective further subsets of graph-based features.

More generally, an anomaly detector 120 computes a density measure for a given data point based on relationships of the given data point to other data points. The anomaly detector 120 uses the density measure to determine whether an entity represented by the given data point is exhibiting anomalous behavior.

In examples according to FIG. 6 where the subset of the graph-based features considered is a pair of graph-based features, then the relationships include pair-wise relationships between the given data point and the other data points.

For large data sets including a large number of data points, searching for the K-nearest neighbors can be expensive from a processing perspective. In alternative implementations of the present disclosure, instead of searching for the K nearest neighbors as new data points are received for consideration, the anomaly detection engine 118 can construct a grid of data points for each subset of graph-based features, identify multiple cells in the grid, and pre-compute the density in each of the cells of the grid. A “grid” can refer to any arrangement of data points where one axis represents one graph-based feature, and another axis represents another graph-based feature. More generally, a grid can be a multi-dimensional grid that has two or more axes that represent respective different graph-based features.

FIG. 7 shows an example of a grid with identified cells (cells 1, 2, 3, . . . , L, L+1, L+2, . . . , shown in FIG. 7), where the axes of the grid represent a first graph-based feature and a second graph-based feature, respectively. Each cell includes a number of data points. The size of each cell can be predefined. The data points in the cells of the grid of FIG. 7 can be data points in a training data set.

As part of a pre-computation phase for the grid of FIG. 7, densities can be computed for each of the cells. The pre-computation phase is discussed below. For each data point in a respective cell, the aggregate distance of the data point to its K nearest neighbors is computed. For example, if cell 1 includes 10 data points, then the aggregate distance of each data point of the 10 data points in cell 1 to the K nearest neighbors of the data point is computed in the pre-computation phase. The aggregate distances of the 10 data points in cell 1 are then further aggregated (e.g., averaged, summed, etc.) to produce a cell density for cell 1.

A similar process is performed for the other cells of the grid of FIG. 7 to compute cell densities of the other cells.

Once all of the cell densities are computed, the pre-computation phase is completed.

Next, an anomaly detection phase is performed for a new data point. In response to receiving the new data point, the K-nearest neighbors of the new data point do not have to be identified. Instead, an anomaly detector 120 locates the cell (of the multiple cells in the grid of FIG. 7) that the new data point corresponds to (based on the values of the first and second graph-based features). For example, based on the values of the first and second graph-based features of the new data point, the anomaly detector 120 determines that the new data point would be part of cell L+1 (or more generally, the new data point corresponds to cell L+1). The density for the new data point is then set based on the pre-computed density of cell L+1. For example, the density for the new data point is set equal to the pre-computed density of cell L+1, or otherwise computed based on the pre-computed density of cell L+1.

The density of the new data point is used as the estimated anomaly score.

In some examples, an index can be used to map a values of the first and second graph-based features of the new data point to a corresponding cell to retrieve the cell density of the corresponding cell. The index correlates ranges of values of the first and second graph-based features to respective cells.

The grid of FIG. 7 includes data points positioned according to a first subset of graph-based features (the first and second graph-based features of FIG. 7). Other grids for other subsets of graph-based features can be provided, and cell densities can be pre-computed for such other subsets of graph-based features. Other anomaly detectors can be used to estimate the density of the new data point based on cell densities of these other grids.

More generally, a given anomaly detector pre-computes density measures for respective cells in a multi-dimensional grid that associates the features of a subset of the derived features. The given anomaly detector determines which given cell of the cells a data point corresponding to an entity falls into, and uses the density measure of the given cell as the computed density measure for the entity, where the computed density measure is used as an anomaly score.

Example Systems

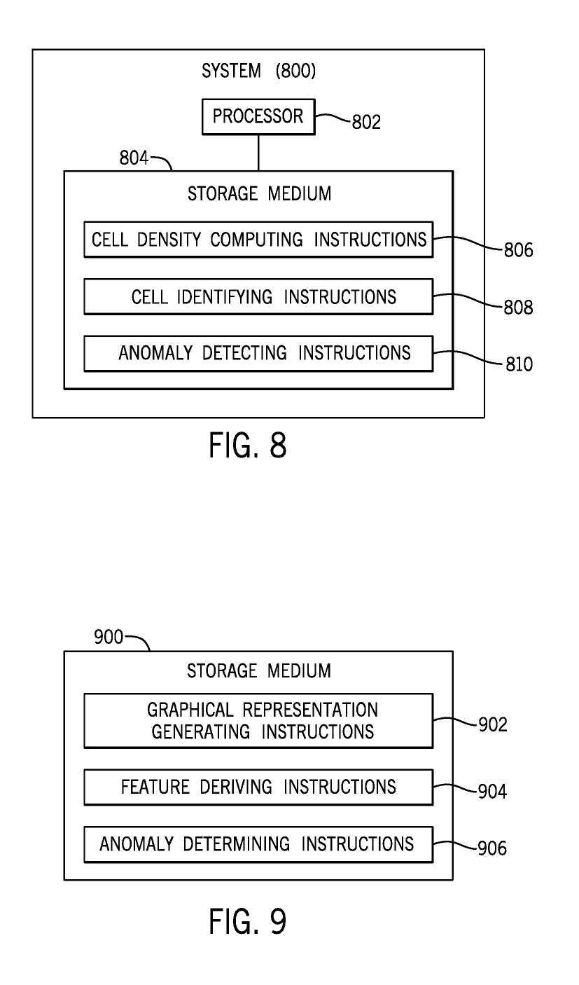

FIG. 8 is a block diagram of a system 800 according to some examples. The system 800 can be implemented as a computer or as a distributed arrangement of computers. The system 800 includes a processor 802 (or multiple processors). A processor can include a microprocessor, a core of a multi-core microprocessor, a microcontroller, a programmable integrated circuit, a programmable gate array, or another hardware processing circuit.

The system 800 further includes a non-transitory machine-readable or computer-readable storage medium 804 storing machine-readable instructions executable on the processor 802 to perform various tasks. Machine-readable instructions executable on a processor can refer to the machine-readable instructions executable on one processor or on multiple processors.

The machine-readable instructions include cell density computing instructions 806 to, for a subset of features of entities associated with a computing environment, pre-compute densities of cells within a multi-dimensional grid (e.g., cells in the grid shown in FIG. 7) that includes data points placed in the multi-dimensional grid according to values of features of a subset of features.

The density pre-computed for a respective cell of the cells is based on relationships between data points in the respective cell and other data points in the multi-dimensional grid.

The machine-readable instructions further include cell identifying instructions 808 to, in response to receiving a data point for a particular entity, identify a cell corresponding to the data point for the particular entity. The machine-readable instructions further include anomaly detecting instructions 810 to use the pre-computed density of the identified cell in determining whether the particular entity is anomalous.

FIG. 9 is a block diagram of a non-transitory machine-readable or computer-readable storage medium 900 storing machine-readable instructions that upon execution cause a system to perform various tasks.

The machine-readable instructions of FIG. 9 include graphical representation generating instructions 902 to generate a graphical representation of entities associated with a computing environment.

The machine-readable instructions of FIG. 9 also include feature deriving instructions 904 to derive features for the entities represented by the graphical representation, the features including neighborhood features and link-based features.

The machine-readable instructions of FIG. 9 further include anomaly determining instructions 906 to determine, using a plurality of anomaly detectors based on respective features of the derived features, whether the first entity is exhibiting anomalous behavior.

The storage medium 804 (FIG. 8) or 900 (FIG. 9) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium storing instructions that upon execution cause a system to:
generate a graphical representation of entities associated with a computing environment;
derive features for the entities represented by the graphical representation, the features comprising neighborhood features and link-based features, a neighborhood feature for a first entity of the entities derived based on entities that are neighbors of the first entity in the graphical representation, and a link-based feature for the first entity derived based on relationships of other entities in the graphical representation with the first entity; and
determine, using a plurality of anomaly detectors based on respective features of the derived features, whether the first entity is exhibiting anomalous behavior.

2. The non-transitory machine-readable storage medium of claim 1, wherein a first anomaly detector of the plurality of anomaly detectors computes a parametric distribution of a subset of the derived features, and determines whether the first entity is exhibiting anomalous behavior based on the parametric distribution.

3. The non-transitory machine-readable storage medium of claim 2, wherein the first anomaly detector determines whether the first entity is exhibiting anomalous behavior based on a threshold for the parametric distribution.

4. The non-transitory machine-readable storage medium of claim 2, wherein the subset of derived features comprises one derived feature, or plural derived features.

5. The non-transitory machine-readable storage medium of claim 2, wherein a second anomaly detector of the plurality of anomaly detectors computes a second parametric distribution of a different second subset of the derived features, and determines whether the first entity is exhibiting anomalous behavior based on the second parametric distribution.

6. The non-transitory machine-readable storage medium of claim 1, wherein a first anomaly detector of the plurality of anomaly detectors:
computes a density measure for a given data point based on relationships of the given data point to other data points, each data point of the given data point and the other data points containing values of features of a subset of the derived features,
uses the density measure to determine whether the first entity is exhibiting anomalous behavior.

7. The non-transitory machine-readable storage medium of claim 6, wherein the subset of the derived features comprises a pair of the derived features, and wherein the relationships comprise pair-wise relationships between the given data point and the other data points.

8. The non-transitory machine-readable storage medium of claim 6, wherein computing the density measure comprises computing distances of the given data point to the other data points in a grid of data points, where the other data points are nearest data points to the given data point, and where the grid of data points includes a plurality of axes representing respective features of the subset of the derived features.

9. The non-transitory machine-readable storage medium of claim 6, wherein the instructions upon execution cause the system to:
pre-compute density measures for respective cells in a multi-dimensional grid that associates the features of the subset of the derived features,
wherein the first anomaly detector determines which given cell of the cells a data point corresponding to the first entity falls into, and uses the density measure of the given cell as the computed density measure for the first entity.

10. The non-transitory machine-readable storage medium of claim 1, wherein the graphical representation of the entities is a first graphical representation of the entities generated based on event data within a first time window of a first time length, and wherein the instructions upon execution cause the system to:
generate a second graphical representation of entities associated with the computing environment based on event data within a second time window of a different second time length;
derive features for the entities represented by the second graphical representation, the features comprising neighborhood features and link-based features; and
determine, using a plurality of anomaly detectors based on respective features of the derived features for the entities represented by the second graphical representation, whether the first entity is exhibiting anomalous behavior.

11. A system comprising:
a processor; and
a non-transitory storage medium storing instructions executable on the processor to:
for a subset of features of entities associated with a computing environment, pre-compute densities of cells within a multi-dimensional grid that includes data points placed in the multi-dimensional grid according to values of features of a subset of features, and wherein a density pre-computed for a respective cell of the cells is based on relationships between data points in the respective cell and other data points in the multi-dimensional grid,
in response to receiving a data point for a particular entity, identify a cell corresponding to the data point for the particular entity and
use the pre-computed density of the identified cell in determining whether the particular entity is anomalous.

12. The system of claim 11, wherein the instructions are executable on the processor to:
derive the features of the entities by:
generating a graphical representation of the entities associated with the computing environment, the graphical representation including nodes representing the entities, and edges representing relationships between the entities; and
calculating the features comprising neighborhood features and link-based features, a neighborhood feature for a first entity of the entities derived based on entities that are neighbors of the first entity in the graphical representation, and a link-based feature for the first entity derived based on relationships of other entities throughout the graphical representation with the first entity.

13. The system of claim 11, wherein the density pre-computed for the respective cell is based on distances of data points in the respective cell to other data points in the multi-dimensional grid.

14. The system of claim 13, wherein the other data points are K nearest neighbors in the multi-dimensional grid each respective data point of the data points in the respective cell.

15. The system of claim 13, wherein the density pre-computed for the respective cell is an aggregate value computed from aggregating the distances.

16. The system of claim 11, wherein the multi-dimensional grid comprises a plurality of axes representing respective features of the subset of features.

17. A method comprising:
generating, by a system comprising a processor, a graphical representation of entities associated with a computing environment;
deriving, by the system, features for the entities represented by corresponding nodes of the graphical representation, wherein an edge between a pair of the nodes represents a relationship between the nodes in the pair, and the features comprise neighborhood features and link-based features, a neighborhood feature for a first entity of the entities derived based on entities that are neighbors of the first entity in the graphical representation, and a link-based feature for the first entity derived based on relationships of other entities throughout the graphical representation with the first entity; and
determining, by the system using a plurality of anomaly detectors based on respective features of the derived features, whether the first entity is exhibiting anomalous behavior.

18. The method of claim 17, further comprising:
ranking the plurality of anomaly detectors to identify a specified number of top-ranked anomaly detectors; and
using detections performed by the specified number of top-ranked anomaly detectors to determine whether the first entity is exhibiting anomalous behavior.

19. The method of claim 17, wherein an anomaly detector of the plurality of anomaly detectors performs anomaly detection using a parametric distribution of a subset of the derived features.

20. The method of claim 17, wherein an anomaly detector of the plurality of anomaly detectors performs anomaly detection using relationships between features of the subset of the derived features.
